(19) United States
(12) Patent Application Publication
(10) Pub. No.: US 2014/0369424 A1
(43) Pub. Date: Dec. 18, 2014

(54) VIDEO CODEC SYSTEM AND VIDEO STREAM TRANSMISSION METHOD

(71) Applicant: Quanta Computer Inc., Kuei Shan Hsiang (TW)

(72) Inventors: Li-An Chuang, Kuei Shan Hsiang (TW); Kai-Ju Cheng, Kuei Shan Hsiang (TW); Chin-Yuan Ting, Kuei Shan Hsiang (TW); Chun-Hsiung Fang, Kuei Shan Hsiang (TW); Hsin-Lun Hsieh, Kuei Shan Hsiang (TW); Yu-Feng Lin, Kuei Shan Hsiang, Tao Yuan Shien (TW)

(73) Assignee: Quanta Computer Inc., Kuei Shan Hsiang (TW)

(21) Appl. No.: 14/012,259

(22) Filed: Aug. 28, 2013

(30) Foreign Application Priority Data
Jun. 17, 2013 (TW) 102121286

(51) Int. Cl. H04N 19/89

(52) U.S. Cl. CPC H04N 19/00933
USPC 375/240.27

(57) ABSTRACT

A video stream transmission method is provided. The method has the following steps of: utilizing a video encoding apparatus to encode a plurality of first images to generate a video bitstream and transmit the video bitstream to the video decoding apparatus over a network; utilizing a video decoding apparatus to decode the video bitstream to generate a plurality of second images correspondingly; and when the video decoding apparatus detects that there is data loss of the video bitstream during transmission, utilizing the video decoding apparatus to reference a third image, which is the most recent completely decoded image of the plurality of second images, to perform subsequent video decoding processes and transmit a request signal to the video encoding apparatus, so that the video encoding apparatus references a fourth image, which corresponds to the third image, of the plurality of first images, to perform subsequent video encoding processes.

### CROSS REFERENCE TO RELATED APPLICATIONS

This Application claims priority of Taiwan Patent Application No. 102121286, filed on Jun. 17, 2013, the entirety of which is incorporated by reference herein.

### BACKGROUND OF THE INVENTION

1. Field of the Invention

The present invention relates to video processing, and in particular, to a video codec system and video stream transmission method without re-transmitting an I-picture while packet loss occurs during video transmission.

2. Description of the Related Art

In video codec standards, there are three image formats: I-picture, P-picture, and B-picture. An I-picture can be decoded without reference to other images. Meanwhile, a P-picture and a B-picture can only be decoded with reference to other images (e.g. previous I-picture or P-picture). When there is packet loss of a video bitstream corresponding to an image during transmission, other images, which reference the image, cannot be decoded correctly. In a conventional video codec system, an instantaneous decoding refresh (IDR) image is used to overcome the aforementioned issue. However, it may take a great amount of bandwidth to transmit an IDR image over a network. Specifically, the conventional technique cannot solve the aforementioned issue effectively for video codec systems having a bad network condition.

### BRIEF SUMMARY OF THE INVENTION

A detailed description is given in the following embodiments with reference to the accompanying drawings.

In an exemplary embodiment, a video codec system is provided. The video codec system comprises a video encoding apparatus and a video decoding apparatus. The video encoding apparatus comprises: a first video processor configured to encode a plurality of first images to generate a video bitstream; a first memory unit configured to store the video bitstream; and a first network unit configured to transmit the video bitstream over a network. The video decoding apparatus comprises: a second network unit configured to receive the video bitstream; a second video processor configured to decode the video bitstream to generate a plurality of second images correspondingly; and a second memory unit configured to store the second images. When the second video processor detects that there is data loss of the video bitstream during transmission, the second video processor references a third image, which is the most recent completely decoded image of the plurality of second images, to perform subsequent video decoding processes, and transmits a request signal to the video encoding apparatus, so that the first video processor references a fourth image, which corresponds to the third image, of the plurality of first images, to perform subsequent video encoding processes.

In another exemplary embodiment, a video stream transmission method for use in a video codec system is provided. The video codec system comprises a video encoding apparatus and a video decoding apparatus. The method comprises: utilizing the video encoding apparatus to encode a plurality of first images to generate a video bitstream and transmit the video bitstream to the video decoding apparatus over a network; utilizing the video decoding apparatus to decode the video bitstream to generate a plurality of second images correspondingly; and when the video decoding apparatus detects that there is data loss of the video bitstream during transmission, utilizing the video decoding apparatus to reference a third image, which is the most recent completely decoded image of the plurality of second images, to perform subsequent video decoding processes and transmit a request signal to the video encoding apparatus, so that the video encoding apparatus references a fourth image, which corresponds to the third image, of the plurality of first images, to perform subsequent video encoding processes.

### BRIEF DESCRIPTION OF THE DRAWINGS

The present invention can be more fully understood by reading the subsequent detailed description and examples with references made to the accompanying drawings, wherein:

FIG. 1 is a schematic block diagram of a video codec system 10 according to an embodiment of the invention;

FIG. 2A-2C are diagrams illustrating video encoding and decoding in the video codec system 10 according to an embodiment of the invention; and

FIG. 3 is a flow chart of the video stream transmission method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

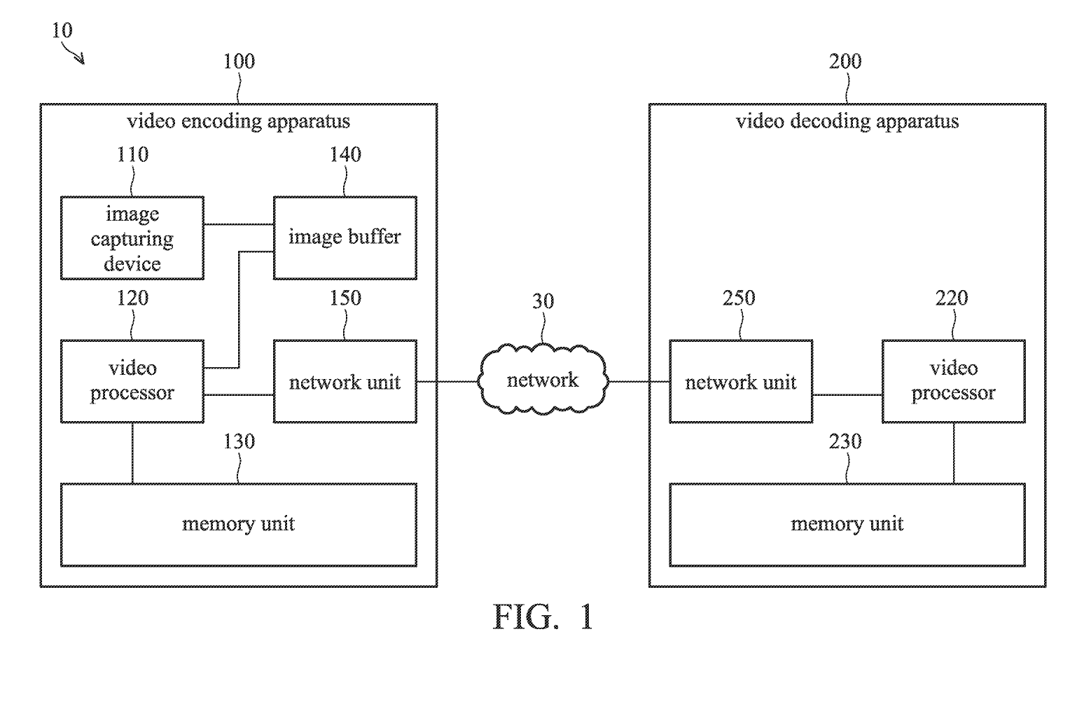

FIG. 1 is a schematic block diagram of a video codec system 10 according to an embodiment of the invention. The video codec system 10 may comprise a video encoding apparatus 100 and a video decoding apparatus 200. In an embodiment, the video encoding apparatus 100 may comprise an image capturing device 110, a video processor 120, a memory unit 130, an image buffer, and a network unit 150. Briefly, the video processor 120 is configured to perform video encoding (e.g. using video codec standards, such as MPEG2,H.263, or H.264/AVC) on a plurality of pictures in a group of pictures (GOP), thereby generating a video bitstream. Then, the video processor 120 may transmit the generated video bitstream to the video decoding apparatus 200 over a network 30 (e.g. a wired network or a wireless network) through the network unit 150.

In the embodiment, the video decoding apparatus 200 may comprise a video processor 220, a memory unit 230, and a network unit 250. The video decoding apparatus 200 may receive network packets of the video bitstream from the video encoding apparatus 100 through the network unit 250, and restore the received network packets to the video bitstream. Then, the video processor 220 may perform video decoding on the video bitstream, thereby obtaining the pictures in the original GOP.

In the aforementioned embodiment, the image capturing device 110 may capture images continuously, and store the captured images into the image buffer 140. The image format of the images stored in the image buffer 140 may be Motion JPEG (MJPG), but the invention is not limited thereto. In an embodiment, the image capturing device 110 can be implemented by CMOS or CCD sensors. The video processor 120 may be a central processing unit (CPU) or a digital signal processor (DSP) (i.e. software), or implemented by a specific video encoding circuit (i.e. hardware). In another embodiment, the video processor 120 may be implemented by combining a CPU or DSP with a specific video encoding circuit (i.e. by both hardware and software). Before starting the video encoding process, the video processor 120 may read the required image stored in the image buffer 140, decode the image to a corresponding raw image (e.g. may be in YUV/YCbCr 4:2:2 or 4:2:0 format), and perform a video encoding processing to the raw image. Specifically, intermediate data required in the video encoding process, raw images, and the generated video bitstream after the video encoding process can be stored in the memory unit 130. The memory unit 130 and the image buffer 140 can be implemented by a non-volatile memory (e.g. a hard disk or flash memory) or a volatile memory (e.g. SRAM or DRAM), but the invention is not limited thereto. The network unit 150 may be a transceiver capable of transmitting/receiving network packets to/from other electronic devices.

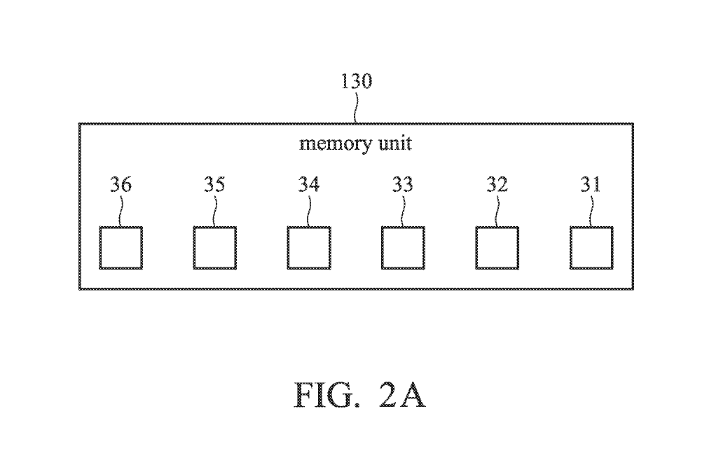

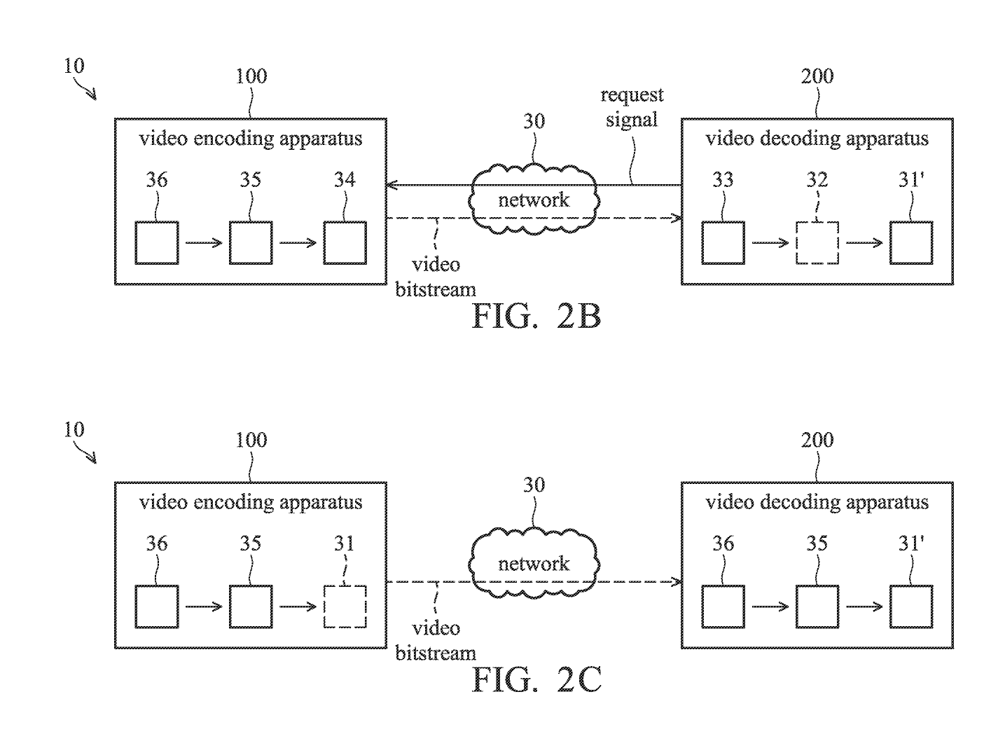

FIG. 2A-2C are diagrams illustrating video encoding and decoding in the video codec system 10 according to an embodiment of the invention. In video coding, the encoded images can be classified as I-pictures, P-pictures, and B-pictures, wherein an I-picture is an intra-coded image, and a P-picture is a predictive-coded image, and a B-picture is a bi-directionally predictive-coded image. When performing video encoding on a P-picture, a previous I-picture or P-picture should be referenced as a reference image. As illustrated in FIG. 2A, the image buffer 140 may store a sufficient amount of images required for the video encoding process, such as images 31 to 36, in order. In the embodiment, for description, the image 31 is encoded as an I-picture, and images 32 to 36 are encoded as P-pictures. In addition, the image 31 is referenced by the image 32, and the image 32 is referenced by the image 33, and so on. Every time when the video processor 120 has completed the video encoding process of a whole image, the video bitstream of the encoded image will be transmitted to the video decoding apparatus 200.

For example, as illustrated in FIG. 2B, the video encoding of the images 31-33 has already been completed by the video processor 120, and the video processor 120 is encoding the image 34. Meanwhile, the video decoding of the image 31 has already been completed by the video processor 220, and the video processor 220 is starting to decode the bitstream corresponding to the image 33. The image 31′, which is obtained after the decoding process, is stored in the memory unit 230 (i.e. the video encoding process is in lossy compression, so that the decoded image is not exactly the same as the original image). When the video processor 220 is decoding the bitstream corresponding to the image 33, the image 32 should be referenced. However, data of the image 32 may be lost due to bad network conditions. Nevertheless, the video processor 220 is further capable of detecting whether any data loss of the video bitstream corresponding to the image 32 (e.g. data of any block of the image 32 is lost) has occurred, and if so, the video decoding on the video bitstream corresponding to the image 33 is stopped. Meanwhile, the video processor 220 may further send a request signal to the video encoding apparatus 100 to rebuild an I-picture or an instantaneous decoding refresh (IDR) image (i.e. in H.264 standard) for subsequent video decoding processes.

As illustrated in FIG. 2C, since the images 31 and 31′ are stored in the video encoding apparatus 100 and the video decoding apparatus 200 correspondingly, the video encoding apparatus 100 may stop the video encoding process on the image 34 upon receiving the request signal, and then start to encode the image 35 as a P-picture with reference to the image 31 as an I-picture (reference image) to generate a corresponding video bitstream, which is further transmitted to the video decoding apparatus 200. Subsequently, the video decoding apparatus 200 may take the image 31′ as an I-picture (reference image), and decode the video bitstream corresponding to the image 35 (i.e. a P-picture referencing to the image 31). The subsequent video decoding process can be performed on the images in a predetermined decoding order, such as decoding the image 36 (P-picture) with reference to the image 35 (also a P-picture). Accordingly, the video encoding apparatus 100 (i.e. a transmitting terminal) may only transmit the video bitstream of P-pictures without re-transmitting the video bitstream corresponding to the image 31 (I-picture) to the video decoding apparatus 200, thereby saving a great amount of bandwidth required for transmitting the video bitstream of an I-picture. In addition, when any data of the video bitstream is lost during transmission, the video decoding apparatus 200 will not reference the image with data loss when performing the video decoding process, thereby preventing the generation of images having artifacts.

Referring to FIG. 2 again, in another embodiment, if the images 36-36 are P-pictures and the assumption of data loss is exactly the same with that as the aforementioned embodiment, the video processor 220 may designate an image, which has a number or an index, in the images, as a reference image. Alternatively, the video processor 220 may also designate the most recent completely decoded image as the reference image. In other words, the image 31′, which is obtained after the decoding process of the video bitstream corresponding to the image 31 by the video processor 220, can be regarded as an I-picture for reference by the video decoding process of subsequent images.

In the aforementioned embodiment, the one-way transmission of the video bitstream from the video encoding apparatus 100 to the video decoding apparatus 200 is described. In some embodiments, the video encoding apparatus 100 and the video decoding apparatus 200 may be both capable of performing video encoding and decoding. Specifically, the video codec system 10 may be a video conferencing system, and the video encoding apparatus 100 and the video decoding apparatus 200 may be video conferencing equipment owned by different users. Upon detection of data loss of the video bitstream during transmission, one of the video encoding apparatus 100 or the video decoding apparatus 200 may transmit a request signal to the other apparatus, so that both of the apparatuses may simultaneously reference the same image, which is the most recent completely decoded image, without re-transmitting the video bitstream of an I-picture, thereby saving the use of additional bandwidth.

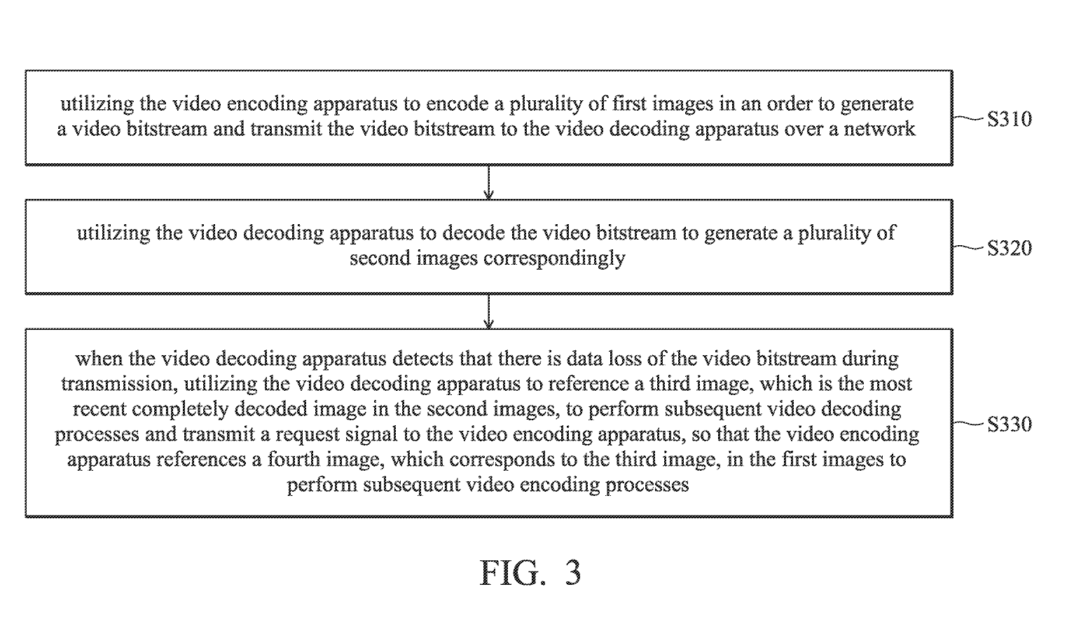

FIG. 3 is a flow chart of the video stream transmission method according to an embodiment of the invention. Referring to both FIG. 1 and FIG. 3, in step S310, the video encoding apparatus 100 may encode a plurality of first images to generate a video bitstream, and transmit the video bitstream to the video decoding apparatus 200 over the network 30. In step S320, the video decoding apparatus 200 may decode the video bitstream to generate a plurality of second images correspondingly. In step S330, when the video decoding apparatus 200 detects that there is data loss of the video bitstream during transmission, the video decoding apparatus 200 may reference a third image, which is the most recent completely decoded image of the plurality of second images (e.g. the image 31′ in FIG. 2C), to perform subsequent video decoding processes, and transmit a request signal to the video encoding apparatus 100, so that the video encoding apparatus 100 may reference a fourth image (e.g. the image 31 in FIG. 2C), which corresponds to the third image, of the plurality of first images to perform the subsequent video encoding processes. It should be noted that the video encoding apparatus may stop the video encoding process on the current image upon receiving the request signal from the video decoding apparatus 200, and use the image, which is designated by the request signal or is the most recent completely decoded image (e.g. the image 31 in FIG. 2C), as a reference image, thereby encoding subsequent images (e.g. the image 35 in FIG. 2C) of the current image.

In view of the above, when there is data loss of the video bitstream during transmission, it is not necessary for the video codec system and the video stream transmission method in the disclosure to re-transmit the video bitstream of an I-picture, thereby saving a great amount of bandwidth for transmitting the video bitstream of an I-picture.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video codec system, comprising:
a video encoding apparatus, comprising:
a first video processor configured to encode a plurality of first images to generate a video bitstream;
a first memory unit configured to store the video bitstream; and
a first network unit configured to transmit the video bitstream over a network; and
a video decoding apparatus, comprising:
a second network unit configured to receive the video bitstream;
a second video processor configured to decode the video bitstream to generate a plurality of second images correspondingly; and
a second memory unit configured to store the second images,
wherein when the second video processor detects that there is data loss of the video bitstream during transmission, the second video processor references a third image, which is the most recent completely decoded image of the plurality of second images, to perform subsequent video decoding processes, and transmits a request signal to the video encoding apparatus, so that the first video processor references a fourth image, which corresponds to the third image, of the plurality of first images, to perform subsequent video encoding processes.

2. The video codec system as claimed in claim 1, wherein the video encoding apparatus further comprises:
an image capturing device configured to capture the plurality of first images continuously; and
an image buffer configured to store the plurality of captured first images.

3. The video codec system as claimed in claim 2, wherein the plurality of first

4. The video codec system as claimed in claim 1, wherein when the video encoding apparatus receives the request signal, the first video processor stops encoding a current image of the plurality of first images, and the first video processor further references the fourth image to encode a subsequent image of the current image.

5. The video codec system as claimed in claim 4, wherein when the video decoding apparatus receives the video bitstream corresponding to the subsequent image of the current image, the second video processor references the third image to decode the video bitstream corresponding to the subsequent image of the current image.

6. A video stream transmission method for use in a video codec system, wherein the video codec system comprises a video encoding apparatus and a video decoding apparatus, the method comprising:
utilizing the video encoding apparatus to encode a plurality of first images to generate a video bitstream and transmit the video bitstream to the video decoding apparatus over a network;
utilizing the video decoding apparatus to decode the video bitstream to generate a plurality of second images correspondingly; and
when the video decoding apparatus detects that there is data loss of the video bitstream during transmission, utilizing the video decoding apparatus to reference a third image, which is the most recent completely decoded image of the plurality of second images, to perform subsequent video decoding processes and transmit a request signal to the video encoding apparatus, so that the video encoding apparatus references a fourth image, which corresponds to the third image, of the plurality of first images, to perform subsequent video encoding

7. The method as claimed in claim 6, wherein the video encoding apparatus further comprises:
an image capturing device configured to capture the plurality of first images continuously; and
an image buffer configured to store the plurality of captured first images.

8. The method as claimed in claim 7, wherein the plurality of first images are stored in the Motion JPEG format.

9. The method as claimed in claim 6, further comprising:
when the video encoding apparatus receives the request signal, utilizing the video encoding apparatus to stop encoding a current image of the plurality of first images, and reference the fourth image to encode a subsequent image of the current image.

10. The method as claimed in claim 9, further comprising:
when the video decoding apparatus receives the video bitstream corresponding to the subsequent image of the current image, utilizing the video decoding apparatus to reference the third image to decode the video bitstream corresponding to the subsequent image of the current image.
